(19) United States
(12) Patent Application Publication
(10) Pub. No.: US 2014/0242306 A1
(43) Pub. Date: Aug. 28, 2014

(54) LOW Tg GLASS GASKET FOR HERMETIC SEALING APPLICATIONS

(71) Applicant: CORNING INCORPORATED, Corning, NY (US)

(72) Inventors: Shari Elizabeth Koval, Beaver Dams, NY (US); Xinghua Li, Horseheads, NY (US); Stephan Lvovich Logunov, Corning, NY (US); Mark Alejandro Quesada, Horseheads, NY (US); William Richard Trutna, Atherton, CA (US)

(73) Assignee: CORNING INCORPORATED, Corning, NY (US)

(21) Appl. No.: 14/270,828

(22) Filed: May 6, 2014

Related U.S. Application Data
(63) Continuation of application No. 13/777,584, filed on Feb. 26, 2013.
(60) Provisional application No. 61/603,531, filed on Feb. 27, 2012.
(60) Provisional application No. 61/653,690, filed on May 31, 2012.

(51) Int. Cl. B32B 17/06

(52) U.S. Cl. CPC B32B 17/06
USPC 428/34

(57) ABSTRACT

A glass-coated gasket comprises a gasket main body defining an inner hole and having a first contact surface and a second contact surface opposite the first contact surface, and a glass layer formed over at least a portion of one of the first contact surface and the second contact surface. The glass layer comprises a low melting temperature glass. A vacuum insulated glass window comprises a substrate/glass-coated gasket/substrate structure that can be sealed using a thermo-compressive sealing step.

### CROSS-REFERENCE TO RELATED APPLICATIONS

This application is a continuation application and claims the priority benefit of U.S. patent application Ser. No. 13/777,584 filed on Feb. 26, 2013, which claims the benefit of priority under 35 U.S.C. §119 of U.S. Provisional Application Ser. No. 61/603,531 filed on Feb. 27, 2012, and U.S. Provisional Application Ser. No. 61/653,690 filed on May 31, 2012, each application being incorporated herein by reference.

### BACKGROUND

The present disclosure relates generally to hermetic barrier layers, and more particularly to methods and compositions used to seal solid structures using low melting temperature glasses.

Recent research has shown that single-layer thin film inorganic oxides, at or near room temperature, typically contain nanoscale porosity, pinholes and/or defects that preclude or challenge their successful use as hermetic barrier layers. In order to address the apparent deficiencies associated with single-layer films, multi-layer encapsulation schemes have been developed. The use of multiple layers can minimize or alleviate defect-enabled diffusion and substantially inhibit ambient moisture and oxygen permeation. Such multi-layer approaches generally involve alternating inorganic and polymer layers, where an inorganic layer is formed both immediately adjacent the substrate or workpiece to be protected and as the terminal or topmost layer in the multi-layer stack.

Although multiple-layer or even single-layer encapsulation techniques may be optimized, such blanket encapsulation approaches are generally confined to implementation within dedicated in-line vacuum systems. Because conventional single and multiple-layer approaches involve complex processing and typically elevated cost, simple, economical hermetic layers and methods for forming them are highly desirable. For instance, it would be desirable to develop hermetic materials and attendant processes for the creation of hermetic encapsulation under atmospheric conditions.

Glass-to-glass bonding techniques can be used to sandwich a workpiece between adjacent substrates and generally provide a degree of encapsulation. Conventionally, glass-to-glass substrate bonds such as plate-to-plate sealing techniques are performed with organic glues or inorganic glass frits. Device makers of systems requiring thoroughly hermetic conditions for long-term operation generally prefer inorganic metal, solder, or frit-based sealing materials because organic glues (polymeric or otherwise) form barriers that are generally permeable to water and oxygen at levels many orders of magnitude greater than the inorganic options. On the other hand, while inorganic metal, solder, or frit-based sealants can be used to form impermeable seals, the resulting sealing interface is generally opaque as a result of the metal cation composition, scattering from gas bubble formation, and distributed ceramic-phase constituents.

Frit-based sealants, for instance, include glass materials that have been ground to a particle size ranging typically from about 2 to 150 microns. For frit-sealing applications, the glass frit material is mixed with a negative CTE material having a similar particle size, and the resulting mixture is blended into a paste using an organic solvent. Example negative CTE inorganic fillers include cordierite particles (e.g. Mg₂Al₃ [AlSi₅O₁₈]) or barium silicates. The solvent is used to adjust the viscosity of the mixture.

To join two substrates, a glass frit layer can be applied to sealing surfaces on one or both of the substrates by spin-coating or screen printing. The frit-coated substrate(s) are initially subjected to an organic burn-out step at relatively low temperature (e.g., 250° C. for 30 minutes) to remove the organic vehicle. Two substrates to be joined are then assembled/mated along respective sealing surfaces and the pair is placed in a wafer bonder. A thermo-compressive cycle is executed under well-defined temperature and pressure whereby the glass frit is melted to form a compact glass seal.

Glass frit materials, with the exception of certain lead-containing compositions, have a glass transition temperature greater than 450° C. and thus require processing at elevated temperatures to form the barrier layer.

Further, the negative CTE inorganic fillers, which are used in order to lower the thermal expansion coefficient mismatch between typical substrates and the glass frit, will be incorporated into the bonding joint and result in a frit-based barrier layer that is neither transparent nor translucent. Further, in contrast to the methods of the present disclosure, realization of the frit seal is accomplished at relatively high temperature and pressure.

Based on the foregoing, it would be desirable to form seals at low temperatures that are both hermetic and transparent.

### SUMMARY

Disclosed herein are materials and systems that can be used to form transparent and/or translucent hermetic barrier layers at low temperature. The barrier layers are thin, impermeable and mechanically robust. For instance, the seal strength between the barrier materials and a cooperating sealing structure (substrate) can be sufficiently strong to accommodate large differences in the coefficient of thermal expansion (CTE) between the adjacent components.

According to one embodiment, a glass-coated gasket can be used to form the barrier layer. The glass-coated gasket comprises a gasket main body defining an inner hole, and having a first contact surface and a second contact surface opposite the first contact surface. A glass layer is formed over at least a portion of one of the first contact surface and the second contact surface. Materials for the glass layer include low melting temperature glasses.

A glass-coated gasket can be used to form a hermetic barrier layer between cooperating substrates, such as opposing glass plates. The substrates and barrier layer can define an interior space where a workpiece to be protected can be positioned. Thus, also disclosed herein are methods of encapsulating a workpiece. In an example method, the workpiece can be disposed on or adjacent to a first one of two substrates. Prior to mating the first substrate with a second substrate, a glass-coated gasket can be positioned peripheral to the workpiece, such that each of the glass-coated surfaces of the gasket are configured to be brought into physical contact with respective sealing surfaces of each substrate. By applying pressure and temperature to the assembly, the glass material in the glass layers can melt and provide a conformal, hermetic seal along the gasket-substrate interfaces.

Embodiments of the present disclosure relate to substrate-to-substrate bonding using a low melting temperature glass-coated gasket. The low melting temperature glass material is disposed along the sealing surfaces as an adhesive and a sealant. The low melting temperature glass materials disclosed herein can be thermally activated to provide a transparent and hermetic seal. In embodiments, the thermal activation can be performed after incorporation of the workpiece into the sealing structure/glass-coated gasket assembly. In further embodiments, the thermal activation can be carried out in conjunction with the application of a suitable pressure, i.e., thermo-compressive activation.

According to a further embodiment, a workpiece can be encapsulated between opposing substrates by initially forming a glass layer on a peripheral sealing surface of a first substrate. The workpiece to be protected can then be positioned between the first substrate and a second substrate such that the glass layer is peripheral to the workpiece. In a sealing step, the glass layer is heated to melt the glass layer and form a glass seal between the first and second substrates. For example, the glass layer can be heated by laser absorption.

The disclosed structures and methods are economically attractive because they obviate the need for expensive vacuum equipment to seal the workpiece. Also, higher manufacturing efficiency can be achieved because the encapsulation rate is determined by thermal activation and bond formation, rather than the deposition rate of the glass layer within a deposition chamber or inert gas assembly line.

A substrate bonding method comprises forming a first glass layer on a sealing surface of a first substrate, forming a second glass layer on a sealing surface of a second substrate, placing at least a portion of the first glass layer in physical contact with at least a portion of the second glass layer, and heating the glass layers to melt the glass layers and form a glass bond between the first and second substrates.

A further substrate bonding method comprises forming a first glass layer on a sealing surface of a first substrate, providing a second substrate, placing at least a portion of the first glass layer in physical contact with at least a portion of a sealing surface of the second substrate, and heating the glass layer to melt the glass layer and form a glass bond between the first and second substrates.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### BRIEF DESCRIPTION OF THE DRAWINGS

FIG. 1 is a schematic diagram of an example process for forming a hermetically-sealed package according to one embodiment;

FIG. 2 is a schematic diagram of a single chamber sputter tool for forming glass-coated gasket;

FIG. 3 is an illustration of an example glass-coated gaskets according to various embodiments;

FIG. 4 is an illustration of a calcium-patch test sample for accelerated evaluation of hermeticity;

FIG. 5 shows test results for non-hermetically sealed (left) and hermetically-sealed (right) calcium patches following accelerated testing;

FIG. 6 is a schematic diagram illustrating the formation of a hermetically-sealed device via laser-sealing according to one embodiment;

FIG. 7 is a photograph of a laser sealed hermetic structure;

FIG. 8 are photographs of planar- and peripherally-sealed surfaces;

FIGS. 9a-9b is one example of an LED assembly comprising low melting temperature glass layers;

FIGS. 10a-10c is a further example of an LED assembly comprising low melting temperature glass layers; and

FIG. 11 is an example vacuum-insulated glass window comprising low melting temperature glass layers.

### DETAILED DESCRIPTION

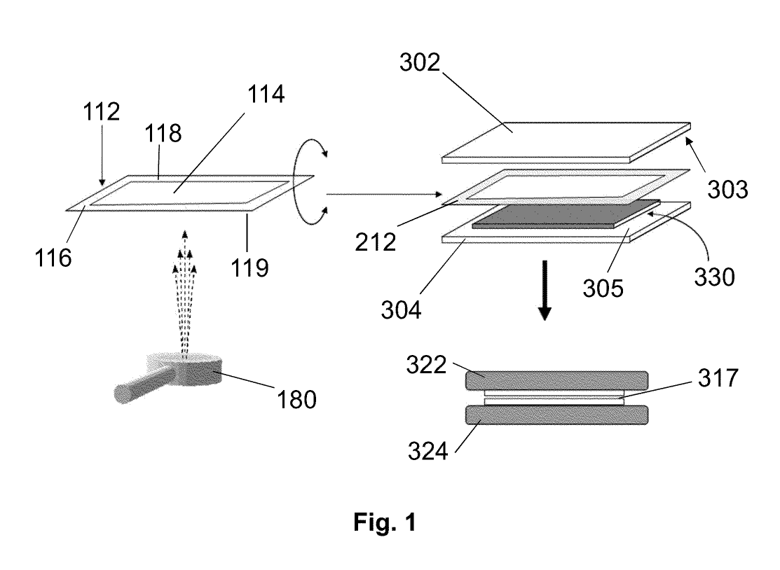

A schematic diagram of an example process for forming a hermetically-sealed package is shown in FIG. 1. In the illustrated example, a square gasket 112 having a central hole 114 has been cut from a 100 micron thick sheet of redrawn Eagle XG® glass using a CO₂ laser to define the gasket main body 116.

Each major surface 118, 119 of the gasket is optionally cleaned and then coated with a 500 nm thick glass layer of low melting temperature glass. The glass layer(s) can be formed on the gasket by any suitable technique, including physical vapor deposition (e.g., sputter deposition or laser ablation) or thermal evaporation of a suitable starting material. In the illustrated example, a glass layer is formed successively on each surface of the gasket via sputter deposition from an evaporation fixture 180 comprising a target of corresponding composition.

After deposition of the glass layers, the glass-coated gasket 212 is assembled into a sandwich structure between opposing substrates 302, 304. The substrates can include glass or ceramic substrate materials. Further example substrates can include metal, metal alloy or composite substrates such as thin film-coated substrates. One example substrate is an indium tin oxide-coated glass substrate. A further example substrate is a molybdenum-coated glass substrate. A still further example substrate is a low-temperature, co-fired ceramic substrate. Optionally, prior to assembly, the sealing surfaces 303, 305 of the substrates, which are located peripheral to workpiece 330, can also be coated with a layer of low melting temperature glass. Within the assembled structure, the workpiece 330 is positioned between substrates 302, 304 within the interior space defined by the gasket main body 116.

As shown in the final step illustrated in FIG. 1, the sandwich structure 317 is placed between anvils 322, 324 within the vacuum chamber of a Suss SB-6 wafer bonder. Within the chamber, a uniaxial pressure (e.g., 10-3000 psi) is applied across a thickness of the assembled structure 317 and the chamber is pumped down to a base pressure of about 10⁻⁴ Torr. The vacuum chamber is then backfilled with nitrogen, and the internal pressure is increased to atmospheric pressure. The compressed structure is heated to a sealing temperature of about 290° C. at a heating ramp rate of 20° C. per minute and held at 290° C. for 30 minutes. The structure is than allowed to cool to room temperature.

Alternatively, the compressed structure can be sealed using a suitable laser as the heating source. The focal point of the laser can swept across the sealing surfaces of the structure to locally melt the glass layer. Example laser processing conditions using a 355 nm laser include a repetition rate 30 kHz (quasi-continuous wave), an average power of 6 W, a beam diameter of about 1 mm, and translation speed of about 1 mm/s. The average temperature to affect sealing is T˜KP/(vD)^{1/2}, where K is a scaling parameter, P is the laser power, v is the translation speed, and D is the beam diameter.

Example lasers (e.g., diode lasers) include IR lasers such as a CO₂ laser, visible lasers such as an argon ion beam laser or a helium-cadmium laser, and UV lasers such as a third-harmonic generating laser.

Suitable UV laser power densities may be chosen to substantially minimize or preclude ablation of the glass material and may range from about 0 to 400 MW/cm², depending on the incident laser wavelength. Suitable laser repetition rates may range from about 10 Hz to about 100 kHz.

A skilled artisan will appreciate that the seal-forming conditions can be adjusted based on the details of the structure including, for example, the gasket geometry, type of substrates, choice of workpiece and/or the composition of the glass material used to form the glass layer(s).

A heating temperature used to melt the low melting temperature glass material can range from the glass transition temperature to the first crystallization temperature of the glass. Melting isotherms within that range can facilitate flow conditions that promote good seal adhesion. In embodiments, the temperature used to melt the glass material can be less than 400° C. (e.g., less than 400, 350, 300, 250 or 200° C.) and can include heating at 400, 350, 300, 250, 200 or 180° C. for a specified period of time. The pressure applied during the heating/melting can range from 10 psi to 3000 psi (e.g., 5, 10, 20, 50, 100, 200, 500, 1000, 1500, 2000, 2500 or 3000 psi). Any suitable heating time can be used to form the glass seal. Heating times can range from 10 minutes to 4 hours (e.g., 10, 30, 60, 120, 180 or 240 minutes). When using laser-based heating, laser exposure times ranging from 1 millisecond to 5 minutes can be used (e.g., 0.001, 0.01, 0.1 or 1 second).

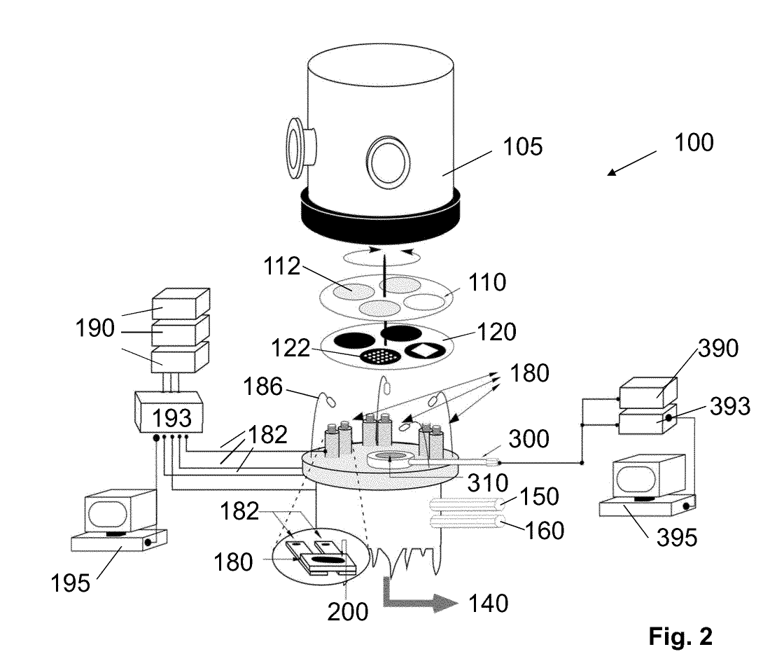

A single-chamber sputter deposition apparatus 100 for forming glass layers on the gasket (and optionally on the sealing surface of a substrate) is illustrated schematically in FIG. 2. The apparatus 100 includes a vacuum chamber 105 having a gasket stage 110 onto which one or more gaskets 112 can be mounted, and an optional mask stage 120, which can be used to mount shadow masks 122 for patterned deposition of different layers onto the gaskets. The chamber 105 is equipped with a vacuum port 140 for controlling the interior pressure, as well as a water cooling port 150 and a gas inlet port 160. The vacuum chamber can be cryo-pumped (CTI-8200/Helix; Mass., USA) and is capable of operating at pressures suitable for both evaporation processes (˜10⁻⁶ Torr) and RF sputter deposition processes (˜10⁻³ Torr).

As shown in FIG. 2, multiple evaporation fixtures 180, each having an optional corresponding shadow mask 122 for evaporating material onto a gasket 112 are connected via conductive leads 182 to a respective power supply 190. A starting material 200 to be evaporated can be placed into each fixture 180. Thickness monitors 186 can be integrated into a feedback control loop including a controller 193 and a control station 195 in order to affect control of the amount of material deposited.

In an example system, each of the evaporation fixtures 180 are outfitted with a pair of copper leads 182 to provide DC current at an operational power of about 80-180 Watts. The effective fixture resistance will generally be a function of its geometry, which will determine the precise current and wattage.

An RF sputter gun 300 having a sputter target 310 is also provided for forming a glass layer on a gasket. The RF sputter gun 300 is connected to a control station 395 via an RF power supply 390 and feedback controller 393. For sputtering glass material onto a gasket, a water-cooled cylindrical RF sputtering gun (Onyx-3™, Angstrom Sciences, PA) can be positioned within the chamber 105. Suitable RF deposition conditions include 50-150 W forward power (<1 W reflected power), which corresponds to a typical deposition rate of about ˜5 Å/second (Advanced Energy, Co, USA). In embodiments, a thickness (i.e., as-deposited thickness) of the glass layer can range from about 200 nm to 50 microns (e.g., about 0.2, 0.5, 1, 2, 5, 10, 20 or 50 microns).

The glass layer can be formed via room temperature sputtering of one or more suitable low melting temperature glass materials or precursors for these materials, though other thin film deposition techniques can be used. In order to accommodate various gasket architectures, the shadow masks 122 can be used to produce a suitably patterned glass layer in situ. Alternatively, conventional lithography and etching techniques can be used to form a patterned glass layer after blanket deposition on a surface of the gasket.

The present disclosure relates to the use of low melting temperature glasses to form hermetic seals. As used herein, a low melting temperature glass has a melting temperature less than 500° C., e.g., less than 500, 400, 350, 300, 250 or 200° C.

According to embodiments, the choice of the glass material(s) and the processing conditions for incorporating the glass materials into the barrier layer are sufficiently flexible that neither the gasket nor the workpiece is adversely affected by formation of the sealed structure.

Exemplary low melting temperature glass materials can include copper oxides, tin oxides, silicon oxides, tin phosphates, tin fluorophosphates, chalcogenide glasses, tellurite glasses, borate glasses, and combinations thereof The glass layer can include one or more dopants, including but not limited to cerium, tungsten and niobium. The optional addition of one or more dopants can increase the absorption of the glass materials at laser processing wavelengths, which can enable the use of laser-based methods for melting and sealing. Example doped glass materials have an absorption at a laser processing wavelength of at least 10% (e.g., at least 20%, 50% or 80%).

Example compositions of suitable tin fluorophosphate glasses include: 20-75 wt. % tin, 2-20 wt. % phosphorus, 10-46 wt. % oxygen, 10-36 wt. % fluorine, and 0-5 wt. % niobium. An example tin fluorophosphate glass includes: 22.42 wt. % Sn, 11.48 wt. % P, 42.41 wt. % O, 22.64 wt. % F and 1.05 wt. % Nb. Example tungsten-doped tin fluorophosphate glasses include: 55-75 wt. % tin, 4-14 wt. % phosphorus, 6-24 wt. % oxygen, 4-22 wt. % fluorine, and 0.15-15 wt. % tungsten. Additional aspects of suitable low melting temperature glass compositions and methods used to form glass layers from these materials are disclosed in commonly-assigned U.S. Pat. No. 5,089,446 and U.S. patent application Ser. Nos. 11/207,691, 11/544,262, 11/820,855, 12/072,784, 12/362,063, 12/763,541 and 12/879,578, the entire contents of which are incorporated by reference herein.

In various embodiments of the present disclosure, the barrier layers are transparent and/or translucent, thin, impermeable, “green,” and configured to form hermetic seals at low temperatures and with sufficient seal strength to accommodate large differences in CTE between the barrier materials and the sealing structures (substrates). In embodiments, the glass layers are free of fillers. In further embodiments, the glass layers are free of binders. In still further embodiments, the glass layers are free of fillers and binders. Further, organic additives are not used to form the hermetic seal. As noted above, the glass materials used to form the glass layer(s) are not frit-based or powders formed from ground glasses.

The gasket material may be an inorganic oxide glass or ceramic that is durable and hermetic to moisture and air. It may be transparent or translucent. Example gaskets may be formed from borosilicate glass, soda lime glass, or aluminosilicate glass.

Substrates that can be bonded together using a glass-coated gasket may comprise an inorganic oxide glass or ceramic. Such a material can be durable and hermetic to moisture and air. The substrates may themselves be transparent or translucent. In addition to glass or ceramic substrates, transparent organic substrates may be used. An organic substrate, if used, may be coated with a hermetic inorganic material. Example glass substrates include borosilicate glasses, soda lime glasses, and aluminosilicate glasses. Example organic substrates include polyacrylate Plexiglas substrates, which may be coated with a glass layer.

According to various embodiments, the present disclosure relates to methods of hermetically encapsulating a workpiece. In one such method, a pair of substrates is sealed together along respective sealing surfaces. A glass-coated gasket is provided along the sealing surfaces and a post-assembly thermo-mechanical treatment is used to melt the glass layer at the sealing surfaces to form a hermetic barrier layer. The glass-coated gasket and the substrates being bonded can cooperate to form an interior volume within which a workpiece to be protected can be situated.

Any suitable heating source can be used to globally or locally heat the glass layer to form the barrier layer. Such heat sources include parallel heated plates, ovens, lasers, etc.

In embodiments, the glass-coated gasket is configured to be conformal or substantially conformal to each of the respective sealing surfaces of the opposing substrates in order to promote formation of a mechanically robust, hermetic seal. While fully hermetic structures are contemplated by various embodiments of the disclosure, “semi-hermetic” structures may also be formed. Semi-hermetic structure may comprise intentional gaps or through-holes that are configured for the conveyance of wires, cable or other materials for a specific application.

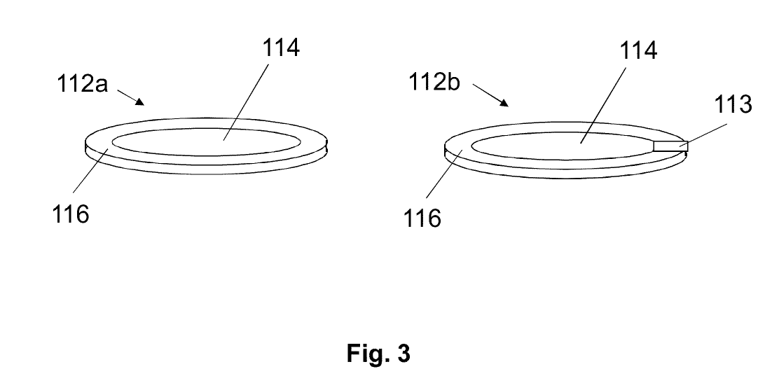

Two example gasket geometries are illustrated in FIG. 3. Each gasket 112a, 112b comprises a gasket main body 116 that defines a hole 114. Gasket 112a comprises a continuous main body, while gasket 112b includes a gap 113 through which, in a sealed structure, a solid, liquid or gaseous element may pass.

The seal strength formed between the glass layer and the opposing substrates can be measured using a conventional wafer bond test, which comprises inserting a standard razor blade between the two sealed substrates and measuring the length of the stable, time-independent open crack that develops. The seal strength γ (in J/m²) can be determined from the degree of delamination, and can be expressed as

$$γ = \frac{3 E {δ}^{2} {t}^{3}}{16 {L}^{4}} ,$$

where E is the Young's modulus of the substrates, δ is derived from the thickness of the razor blade, t is the substrate thickness, and L is the equilibrium crack length.

According to embodiments, after sealing, the seal strength between the sealing structure and the gasket is greater than 0.05 J/m² (e.g., about 0.05, 0.1, 0.2, 0.3, 0.4 or 0.5 J/m²).

To evaluate the hermeticity of proposed glass compositions, calcium patch test samples were prepared using the single-chamber sputter deposition apparatus 100. In a first step, calcium shot (Stock #10127; Alfa Aesar) was evaporated through a shadow mask 122 to form 25 calcium dots (0.25 inch diameter, 100 nm thick) distributed in a 5×5 array on a 2.5 inch square glass substrate. For calcium evaporation, the chamber pressure was reduced to about 10⁻⁶ Torr. During an initial pre-soak step, power to the evaporation fixtures 180 was controlled at about 20 W for approximately 10 minutes, followed by a deposition step where the power was increased to 80-125 W to deposit about 100 nm thick calcium patterns on each substrate.

Following evaporation of the calcium, the patterned calcium patches were encapsulated using comparative inorganic oxide materials as well as hermetic low melting temperature glass materials according to various embodiments. The glass materials were deposited using room temperature RF sputtering of pressed powder sputter targets. The pressed powder targets were prepared separately using a manual heated bench-top hydraulic press (Carver Press, Model 4386, Wabash, Ind., USA). The press was typically operated at 20,000 psi for 2 hours and 200° C.

The RF power supply 390 and feedback control 393 (Advanced Energy, Co, USA) were used to form glass layers directly over the calcium having a thickness of about 2 micrometers. No post-deposition heat treatment was used. Chamber pressure during RF sputtering was about 1 milliTorr.

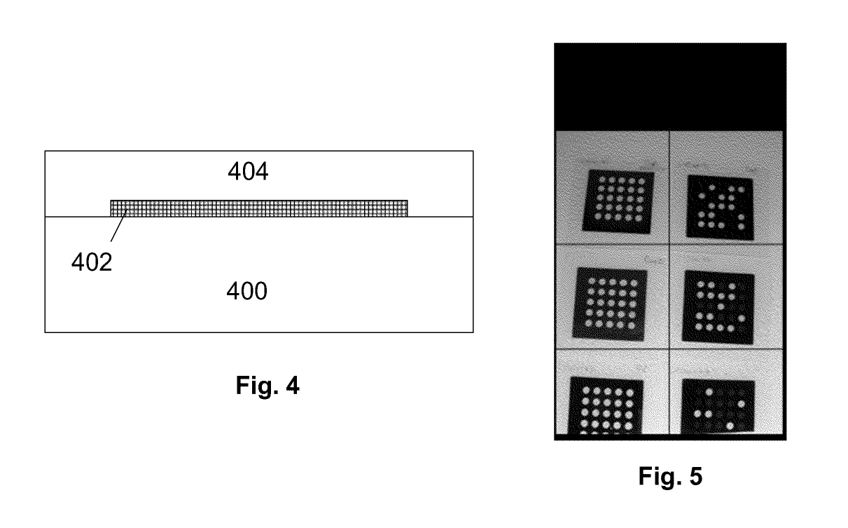

FIG. 4 is a cross-sectional view of a test sample comprising a glass substrate 400, a patterned calcium patch (˜100 nm) 402, and a glass layer (˜2 μm) 404. In order to evaluate the hermeticity of the glass layer, calcium patch test samples were placed into an oven and subjected to accelerated environmental aging at a fixed temperature and humidity, typically 85° C. and 85% relative humidity (“85/85 testing”).

The hermeticity test optically monitors the appearance of the vacuum-deposited calcium layers. As-deposited, each calcium patch has a highly reflective metallic appearance. Upon exposure to water and/or oxygen, the calcium reacts and the reaction product is opaque, white and flaky. Survival of the calcium patch in the 85/85 oven over 1000 hours is equivalent to the encapsulated film surviving 5-10 years of ambient operation. The detection limit of the test is approximately 10⁻⁷ g/m² per day at 60° C. and 90% relative humidity.

FIG. 5 illustrates behavior typical of non-hermetically sealed and hermetically sealed calcium patches after exposure to the 85/85 accelerated aging test. In FIG. 5, the left column shows non-hermetic encapsulation behavior for Cu₂O films formed directly over the patches. All of the Cu₂O-coated samples failed the accelerated testing, with catastrophic delamination of the calcium dot patches evidencing moisture penetration through the Cu₂O layer. The right column shows positive test results for nearly 50% of the samples comprising a CuO-deposited hermetic layer. In the right column of samples, the metallic finish of 34 intact calcium dots (out of 75 test samples) is evident.

The permeability coefficients of the barrier layers disclosed herein can be orders of magnitude greater than the values that can be achieved using organic material-based seals. Devices that are sealed using the disclosed materials and methods can exhibit water vapor transmission (WVTR) conditions less than 10⁻⁶ g/m²/day, which enables long-life operation.

A hermetic layer is a layer which, for practical purposes, is considered substantially airtight and substantially impervious to moisture. By way of example, the hermetic barrier layer can be configured to limit the transpiration (diffusion) of oxygen to less than about 10⁻² cm³/m²/day (e.g., less than about 10⁻³ cm³/m²/day), and limit the transpiration (diffusion) of water to about 10⁻² g/m²/day (e.g., less than about 10⁻³, 10⁻⁴, 10⁻⁵ or 10⁻⁶ g/m²/day). In embodiments, the hermetic thin film substantially inhibits air and water from contacting an underlying workpiece.

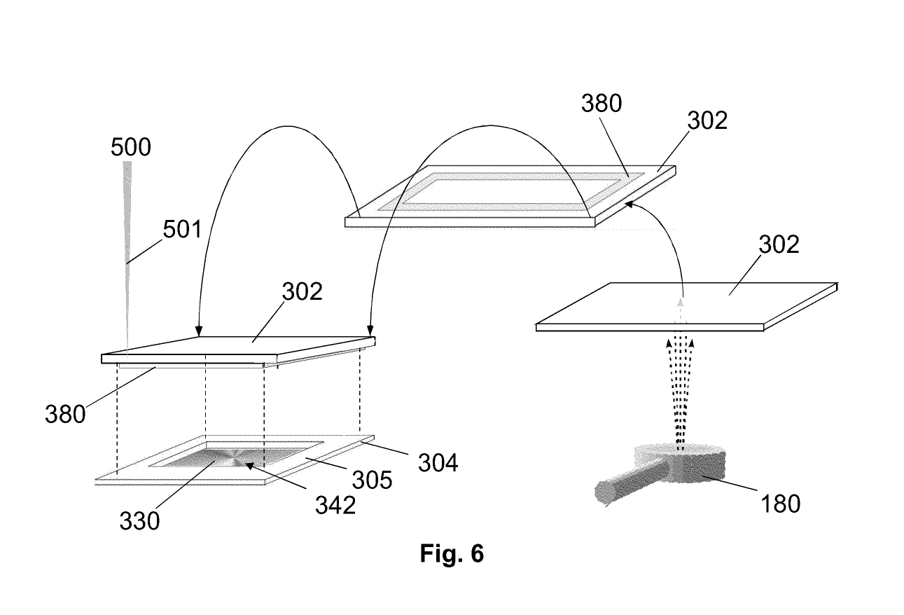

A method of forming an encapsulated workpiece according to one embodiment is illustrated schematically in FIG. 6. In initial step, a patterned glass layer 380 is formed along a sealing surface of a first planar glass substrate 302. The glass layer is formed along a peripheral sealing surface adapted to engage with a sealing surface of a second glass substrate 304. The first and second substrates, when brought into a mating configuration, cooperate with the glass layer to define an interior volume 342 that contains a workpiece 330 to be protected. In the illustrated example, which shows an exploded image of the assembly, the second substrate comprises a recessed portion within which the workpiece 330 is situated.

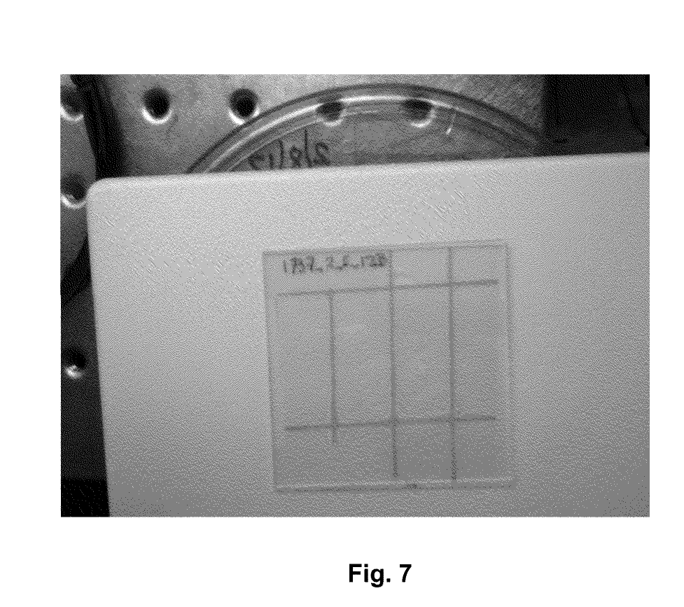

A focused laser beam 501 from laser 500 can be used to melt the low temperature glass and form the barrier layer. In one approach, the laser can be focused through the first substrate 302 and then translated (scanned) across the sealing surface to locally heat the glass material and form the barrier layer. In order to affect local melting of the glass layer, the glass layer is preferably absorbing at the laser processing wavelength while the substrates are transparent (e.g., at least 50%, 70% or 90% transparent) at the laser processing wavelength. A photograph of a laser-sealed hermetic structure is shown in FIG. 7. In a non-illustrated embodiment, a glass layer can first be formed on a suitable gasket and the glass-coated gasket can be disposed between the sealing surfaces of the first and second substrates.

Laser sealing approaches may involve welding processes and/or soldering processes. In a welding process, for example, localized melting occurs in both the glass layer(s) and in at least a portion of one or both of the sealing surfaces of the glass substrate(s). In a soldering process, on the other hand, localized melting occurs in the glass layer(s) while melting is substantially avoided in the glass substrate(s).

Photographs exhibiting planar sealing and peripheral sealing of glass substrates are shown in FIG. 8. In each example, a 500 nm thick glass layer was initially deposited on respective contact surfaces, which were then brought into contact and bonded by applying pressure at elevated temperature. The top row in FIG. 8 shows two magnesium fluoride glass windows that were pressure bonded at 1132 psi with a Carver press held at 180° C. for 1 hour in air. The sealed glass sandwich structures shown in the middle row were pressure bonded at 10 psi with a Suss SB-6 wafer bonder, and held at either 290° C. (left) or 350° C. (right) for 30 minutes. In each of these examples, a razor blade has been inserted between the opposing glass sheets to evaluate the strength of the sealing interface. The sealed glass gasket structure in the bottom row was pressure bonded at 10 psi, and held at 350° C. for 30 minutes with a Suss SB-6 wafer bonder.

In the foregoing examples, the magnesium fluoride windows were sealed using an un-doped tin fluorophosphate glass (top left) and a tungsten-doped tin fluorophosphate glass (top right). The center row and bottom row samples shown in FIG. 8 were sealed using a niobium-doped tin fluorophosphate composition. The example un-doped, tungsten-doped and niobium-doped compositions, expressed as a weight percentage of starting materials, is summarized in Table 1.

In embodiments, a glass layer can be formed on a contact surface of a glass gasket. In further embodiments, a glass layer can be formed on a contact surface of a glass substrate.

TABLE 1
Low melting temperature glass compositions

| | un-doped | W-doped | Nb-doped |
|---|---|---|---|
| SnF₂ | 38.1 | 37.7 | 37.5 |
| SnO | 33.5 | 31.7 | 31.5 |
| NH₄H₂PO₄ | 28.4 | 27.9 | 27.9 |
| Nb₂O₅ | — | — | 3.0 |
| WO₃ | — | 2.7 | — |

Low melting temperature glasses can be used to seal or bond different types of substrates. Sealable and/or bondable substrates include glasses, glass-glass laminates, glass-polymer laminates or ceramics, including gallium nitride, quartz, silica, calcium fluoride, magnesium fluoride or sapphire substrates. In embodiments, one substrate can be a phosphor-containing glass plate, which can be used, for example, in the assembly of a light emitting device. Substrates can have any suitable dimensions. Substrates can have areal (length and width) dimensions that independently range from 1 cm to 5 m (e.g., 0.1, 1, 2, 3, 4 or 5 m) and a thickness dimension that can range from about 0.5 mm to 2 mm (e.g., 0.5, 0.6, 0.7, 0.8, 0.9, 1.0, 1.2, 1.5 or 2 mm) In further embodiments, a substrate thickness can range from about 0.05 mm to 0.5 mm (e.g., 0.05, 0.1, 0.2, 0.3, 0.4 or 0.5 mm) In still further embodiments, a substrate thickness can range from about 2 mm to 10 mm (e.g., 2, 3, 4, 5, 6, 7, 8, 9 or 10 mm).

A phosphor-containing glass plate comprising one or more of a metal sulfide, metal silicate, metal aluminate or other suitable phosphor, can be used as a wavelength-conversion plate in white LED lamps. White LED lamps typically include a blue LED chip that is formed using a group III nitride-based compound semiconductor for emitting blue light. White LED lamps can be used in lighting systems, or as backlights for liquid crystal displays, for example. The low melting temperature glasses disclosed herein can be used to seal or encapsulate the LED chip.

Hermetic encapsulation of a workpiece using the disclosed materials and methods can facilitate long-lived operation of devices otherwise sensitive to degradation by oxygen and/or moisture attack. Example workpieces, devices or applications include flexible, rigid or semi-rigid organic LEDs, OLED lighting, OLED televisions, photovoltaics, MEMs displays, electrochromic windows, fluorophores, alkali metal electrodes, transparent conducting oxides, quantum dots, etc.

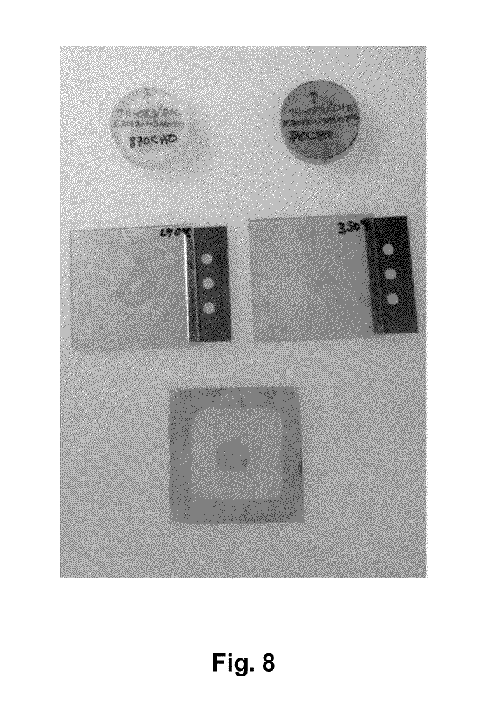

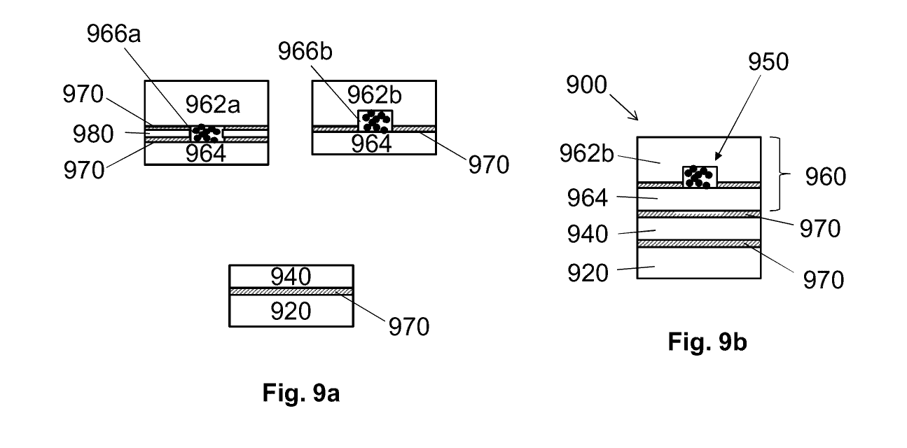

A simplified schematic showing a portion of an LED assembly is depicted in FIG. 9a and FIG. 9b. Components of the assembly according to various embodiments are shown in FIG. 9a, and an example of an assembled architecture is shown in FIG. 9b. The LED assembly 900 includes an emitter 920, a wavelength-conversion plate 940, and a quantum dot sub-assembly 960. As explained in further detail below, glass layers can be used to bond and/or seal various components of the LED assembly. In the illustrated embodiment, the wavelength-conversion plate 940 is disposed directly over the emitter 920, and the quantum dot sub-assembly 960 is disposed directly over the wavelength-conversion plate 940.

One component of the LED assembly 900 is a quantum dot sub-assembly 960, which in various embodiments includes a plurality of quantum dots 950 disposed between an upper plate 962a, 962b and a lower plate 964. The quantum dots in one embodiment are located within a cavity 966a that is defined by upper plate 962a, lower plate 964 and glass-coated gasket 980. In an alternate embodiment, the quantum dots are located within a cavity 966b that is formed in the upper plate 962b, and which is defined by upper plate 962b and lower plate 964. In the first embodiment, the upper plate 962a and the lower plate 964 can be sealed along respective contact surfaces by a glass-coated gasket 980 having respective glass layers 970. In the second embodiment, the upper plate 962b and the lower plate 964 can be directly sealed along respective contact surfaces by a glass layer 970. In non-illustrated embodiments, quantum dots may be encapsulated by a low-melting temperature glass within the cavities 966a, 966b.

A thermo-compressive stress may be applied to affect sealing between the upper and lower plates, or the interface(s) may be laser sealed by focusing a suitable laser on or near the glass layer(s) through either of the upper or lower plates.

A further component of the LED assembly 900 is an emitter 920 with a wavelength-conversion plate 940 formed over an output of the emitter. The emitter 920 can include a semiconductor material such as a gallium nitride wafer, and the wavelength-conversion plate 940 can comprise a glass or ceramic having particles of a phosphor embedded or infiltrated therein. In embodiments, a low melting temperature glass can be used to directly bond a sealing surface of the wavelength-conversion plate to a sealing surface of the emitter.

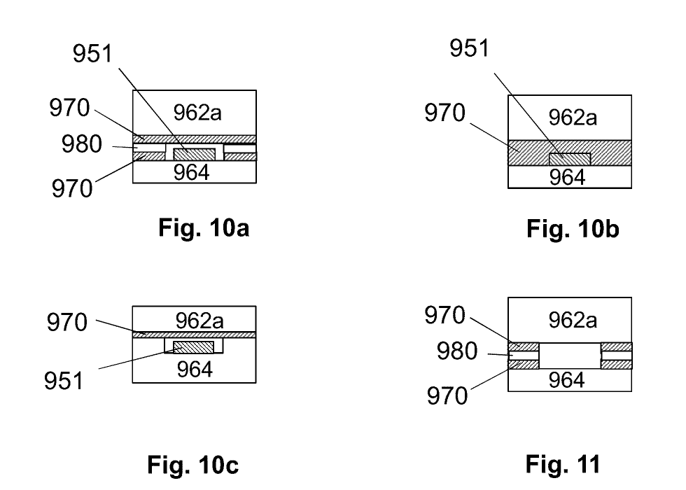

Alternate embodiments, which include example photovoltaic (PV) device or organic light emitting diode (OLED) device architectures, are depicted in FIG. 10. As shown in FIG. 10a, active component 951 is located within a cavity that is defined by upper plate 962a, lower plate 964 and glass-coated gasket 980. Glass layers 970 can be formed between opposing sealing surfaces in the upper plate and the glass-coated gasket, and in the glass-coated gasket and the lower plate, respectively. The geometry illustrated in FIG. 10a is similar to the geometry of FIG. 9a, except the upper glass layer in FIG. 10a extends beyond the contact surface with gasket 980. Such an approach may be beneficial insomuch as a patterning step of the upper glass layer may be omitted. In the example of an OLED display, active component 951 may include an organic emitter stack that is sandwiched between an anode and a cathode. The cathode, for example can be a reflective electrode or a transparent electrode.

Illustrated in FIG. 10b is a geometry where active component 951 is encapsulated between upper plate 962a and lower plate 964 using a conformal glass layer 970. Illustrated in FIG. 10c is a structure where active component 951 is located within a cavity that is defined by upper plate 962a and lower plate 964. The geometry illustrated in FIG. 10c is similar to the geometry of FIG. 9b, except the glass layer in FIG. 10c extends beyond the contact surface between the upper and lower glass plates.

To form a seal or bond between respective sealing surfaces, initially a glass layer may be formed on one or both of the surfaces. In one embodiment, a glass layer is formed over each of the surfaces to be bonded, and after the surfaces are brought together, a thermo-compressive stress is used to melt the glass layers and create the seal. In one further embodiment, a glass layer is formed over only one of the surfaces to be bonded, and after the glass-coated surface and non-glass-coated surface are brought together, a focused laser is used to melt the glass layer and create the seal.

A method of bonding two substrates comprises forming a first glass layer on a sealing surface of a first substrate, forming a second glass layer on a sealing surface of a second substrate, placing at least a portion of the first glass layer in physical contact with at least a portion of the second glass layer, and heating the glass layers to melt the glass layers and form a glass bond between the first and second substrates.

In alternate embodiments, the sealing approaches disclosed herein can be used to form vacuum-insulated glass (VIG) windows where the previously-discussed active components (such as the emitter, collector or quantum dot architecture) are omitted from the structure, and a low melting temperature glass layer, optionally in combination with a glass-coated gasket, is used to seal respective bonding interfaces between opposing glass panes in a multi-pane window. A simplified VIG window architecture is shown in FIG. 11, where opposing glass panes 962a, 964 are separated by a glass-coated gasket 980 that is positioned along respective peripheral sealing surfaces.

In each of the sealing architectures disclosed herein, sealing using a low melting temperature glass layer may be accomplished by the heating, melting and then cooling of such a glass layer using, for example, laser energy or localized conventional heating to locally treat the glass layer between respective sealing surfaces, or by heating and cooling the entire assembly to create a seal.

The disclosed low melting temperature glasses, glass-coated gaskets and attendant methods for forming bonded or sealed surfaces between respective substrates or workpieces are suitable for batch processing as well as continuous or roll-to-roll processing.

As used herein, the singular forms “a,” “an” and “the” include plural referents unless the context clearly dictates otherwise. Thus, for example, reference to a “layer” includes examples having two or more such “layers” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

It will be apparent to those skilled in the art that various modifications and variations can be made to the present disclosure without departing from the spirit and scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A vacuum-insulated glass (VIG) window, comprising:
a first glass pane;
a second glass pane opposing the first glass pane;
a glass-coated gasket positioned intermediate the first and second glass panes and along the periphery thereof, the glass coated gasket having a first contact surface contacting the first glass pane and a second contact surface contacting the second glass pane; and
a glass layer formed over at least a portion of one of the first contact surface and the second contact surface.

2. The VIG window according to claim 1, wherein the glass layer comprises a glass material selected from the group consisting of tin fluorophosphate glasses, tungsten-doped tin fluorophosphate glasses, chalcogenide glasses, tellurite glasses, borate glasses and phosphate glasses.

3. The VIG window according to claim 1, wherein the glass layer comprises a glass material including:
20-75 wt. % Sn,
2-20 wt. % P,
10-36 wt. % O,
10-36 wt. % F, and
0-5 wt. % Nb.

4. The VIG window according to claim 1, wherein the glass layer comprises a glass material including:
55-75 wt. % Sn,
4-14 wt. % P,
6-24 wt. % O,
4-22 wt. % F, and
0.15-15 wt. % W.

5. The VIG window according to claim 1, wherein the glass layer comprises a glass material having a glass transition temperature less than 400° C.

6. The VIG window according to claim 1, wherein the glass layer comprises a glass material having a melting temperature less than 500° C.

7. The VIG window according to claim 1, wherein the glass layer comprises a glass material having a melting temperature less than a crystallization temperature.

8. The VIG window according to claim 1, wherein the glass layer is formed over substantially all of at least one of the first contact surface and the second contact surface.

9. The VIG window according to claim 1, wherein the glass layer is formed over substantially all of both the first contact surface and the second contact surface.

10. The VIG window according to claim 1, wherein the glass layer has an average thickness of from about 200 nm to 50 microns.

11. The VIG window according to claim 1, wherein a seal strength between the glass layer and the glass gasket is at least 0.05 J/m².

12. The VIG window according to claim 1, wherein the glass layer is optically translucent.

13. The VIG window according to claim 1, wherein the glass layer is optically transparent.
